(19) United States
(12) Patent Application Publication
(10) Pub. No.: US 2023/0211816 A1
(43) Pub. Date: Jul. 6, 2023

(54) Buffer, in particular for a rail vehicle

(71) Applicant: Faiveley Transport Schwab AG, Schaffhausen (CH)

(72) Inventor: Stefan Faas, Appenzell (CH)

(73) Assignee: Faiveley Transport Schwab AG, Schaffhausen (CH)

(21) Appl. No.: 18/146,500

(22) Filed: Dec. 27, 2022

(30) Foreign Application Priority Data
Jan. 3, 2022 (CH) 000006/2022

(51) Int. Cl. B61G 11/12; B61G 7/10; B61G 11/18

(52) U.S. Cl. CPC B61G 11/12; B61G 7/10; B61G 11/18

(57) ABSTRACT

Buffer, in particular for a rail vehicle, includes a buffer sleeve, forming a pressure chamber, a jointed head securable to this sleeve on the face side by a connection flange, and a buffer piston rod, mounted opposite in the buffer sleeve to be displaceable longitudinally. The jointed head is connectable in a jointed manner to the rail vehicle, while the buffer piston rod is preferably connectable to a coupling head. The connection flange has an outer thread on its outer casing, screwed to an inner thread in a hole of the buffer sleeve to form a releasable connection of the jointed head with the buffer sleeve. The connection flange preferably has on the front side a centering tip element before the outer thread, which is slid or pressed essentially free of play into the hole of the buffer sleeve.

### FIELD OF THE INVENTION

The invention relates to a buffer, in particular for rail vehicles, which is provided with a buffer sleeve, forming a pressure chamber, a jointed head which can be secured to this on the face side by a connection flange, and located opposite this, a buffer piston rod, mounted such as to be displaceable longitudinally in the buffer sleeve. The jointed head can be connected by a joint to the rail vehicle, while the buffer piston rod can be connected to a coupling head or other connecting elements of the rail vehicle.

### BACKGROUND OF THE INVENTION

Buffers of this type serve rail vehicles as traction and impact devices, for damping the pressure and traction forces which take effect on the coupling of the rail vehicle when in operation. A known device according to the printed specification CH 717 058 A2, which is considered to correspond to EP 3 855 043 A1, is equipped with a piston-cylinder unit as a damping device, integrated in the draw bar of the vehicle, wherein the cylinder is secured to the jointed head, and the piston or piston rod is secured to the coupling head of the rail vehicle.

Known buffers, with a buffer sleeve forming the pressure chamber, are equipped either with a bayonet connection between the buffer sleeve and the jointed head, or, as an alternative, they can comprise in each case a centering flange, which can be secured to the buffer sleeve, opposite the jointed head, which holds the buffer piston rod in the buffer sleeve. In this situation, the centering flange is secured by a plurality of securing screws distributed over the outside, while on the opposing side the jointed head is connected to the buffer sleeve. It is self-explanatory that such a structural arrangement renders the assembly of the buffer difficult, especially since assembly can only be carried out by rotating from two sides.

### OBJECTS AND SUMMARY OF THE INVENTION

The invention is based on the object of avoiding these disadvantages and providing a buffer of the type referred to in the preamble, which with simple constructive means allows for easy assembly, is secure in operation, and which ensures that it can be assembled from only one side, without rotation.

This object is solved according to the invention in that the connection flange of the jointed head comprises on its outer casing an outer thread, which interacts with an inner thread provided in a hole in the buffer sleeve in order to form a detachable connection between the jointed head and the buffer sleeve, wherein the connection flange is provided on the front side with a centering tip element arranged in front of the outer thread and which can slide essentially free of play into the hole in the buffer sleeve.

The buffer according to the invention is characterized in that it can be assembled simply by screwing the buffer sleeve to the connection flange, these being reliably guided coaxially towards one another by means of the centering tip element, wherein their final installation location relative to one another is determined relatively precisely by the stepping configuration of the buffer sleeve, serving as a contact surface.

The buffer according to the invention further has the advantage that both the outer thread and inner thread, as well as the centering tip element and the stepping configuration in the interior of the buffer sleeve, serving as the contact surface, are well protected.

Very advantageously, the hole in the buffer sleeve comprises an annular stepped configuration behind the inner thread, which serves as a contact surface for the connection flange in the buffer sleeve.

With this structural arrangement, it is also possible, appropriate for the purpose, for at least one anti-rotation securing means to be provided, accessible from the outside, with which, in the assembled state, the connection flange of the jointed head is blocked at the buffer sleeve. Advantageously, the buffer can be provided with two diametrically opposed anti-rotation securing means.

In the interests of easy handling and operationally reliable function, it is to the purpose in this situation if the anti-rotation securing means are configured as clamping shoes which engage in cut-out openings in the buffer sleeve and the connection flange, which are fixed to the connection flange by screws arranged radially.

The invention further makes provision for the buffer piston rod to be provided with an anti-rotation securing means which ensures the free sliding displacement of the buffer piston rod in the buffer sleeve. It is to the purpose in this situation if this is composed of two diametrically opposed longitudinal wedge elements, formed between the buffer piston rod and buffer sleeve, and corresponding longitudinal grooves. In this situation it is also of advantage that the anti-rotation securing means in the interior of the buffer sleeve is well protected.

### BRIEF DESCRIPTION OF THE DRAWINGS

The invention is explained in greater detail hereinafter on the basis of exemplary embodiments and by reference to the drawing. The Figures show:

FIG. 1 is a perspective view of a buffer according to the invention,

FIG. 2 shows the buffer according to FIG. 1, represented in a perspective longitudinal section, and

FIG. 3 is an enlarged cross-section through the detail X according to FIG. 2.

### DETAILED DESCRIPTION OF THE INVENTION

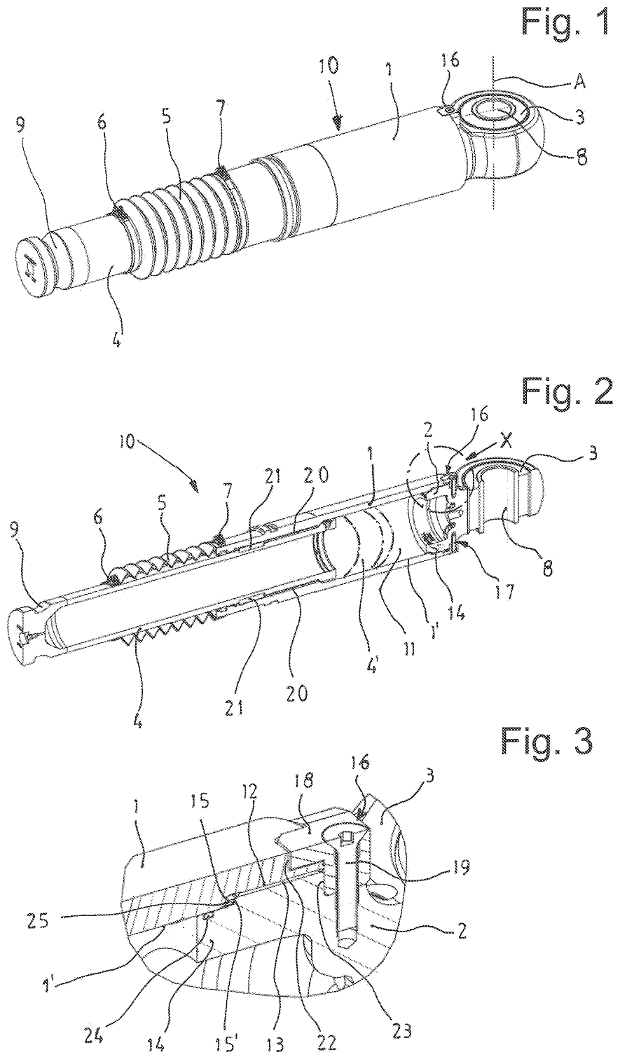

The buffer 10 according to FIG. 1 to FIG. 3 is composed of a buffer sleeve 1, a jointed head 3, which can be secured to this buffer sleeve on the face side by means of a connection flange 2, and an opposing buffer piston rod 4 which is mounted such as to be longitudinally displaceable in the buffer sleeve 1. Also provided is a sealing bellows element 5 on the outside between the buffer piston rod 4 and the buffer sleeve 1, which is secured at both ends by pipe clamps 6, 7 or the like. The jointed head comprises a hole 8, in which a bolt engages of a coupling flange or the like, on the vehicle side.

With this buffer 10, the jointed head 3 can be connected in a jointed manner to a sleeve or the like on the rail vehicle, while the buffer piston rod 4 can be connected to a coupling head, which can be coupled to or uncoupled from a coupling head of a rail vehicle which is to be coupled up. Instead of a coupling head, it is also possible for another connecting element, such as an extension rod or connecting rod or the like, to be connected in a jointed manner. On the end side, at the buffer piston rod 4, an annular groove 9 is provided, for securing the coupling head or a connection element.

Such a buffer 10 is used preferably with goods wagons or passenger coaches, on locomotives or other wagons of rail vehicles of train compositions. In this situation it serves as traction and impact devices, for damping the pressure and traction forces which take effect on the coupling of the rail vehicle when in operation.

Displaceably arranged in the buffer sleeve 1 is a piston rod unit 4′, indicated in FIG. 2 by broken lines, which is secured on the end side to the buffer piston rod 4. This piston rod unit 4′ delimits a pressure chamber 11, formed in the interior of the buffer sleeve 1, and, when in operation, it brings about pressure compensation in the pressure chamber 11, and together with this therefore forms a damping device for damping the pressure and traction forces taking effect on the buffer.

According to the invention, the securing of the buffer sleeve 1 to the jointed head 3 of the buffer 10 is configured as a releasable screw connection, which is composed of an outer thread 12 in the outer casing of the connection flange 2 and, interacting with this, an inner thread 13 in the hole of the buffer sleeve 1.

In order to make the assembly of the buffer 10 easier, the connection flange 2 is provided on the front side with a centering tip element 14, arranged in front of the outer thread 12, which can be slid or pressed into the hole in the buffer sleeve 1 essentially free of play. As a result, a coaxial centering of the connection flange in the buffer sleeve is ensured after the assembly has been screwed together. This connection flange 2 is formed in a sleeve shape in the region of the outer thread 12 and of the centering tip element 14 following this. It may equally well be configured as a pivot or journal element or the like. Indicated on the outside at the centering tip element 14 is also an annular groove 24 with a seal within it.

In addition to this, the hole 1′ in the buffer sleeve 1 comprises, immediately behind the inner thread 13 is an annular stepping configuration 15, which serves as a contact surface for a shoulder 15′ of the connection flange 2 in the buffer sleeve 1. Very advantageously, a spacer ring 25 is arranged in this stepping configuration 15 between it and the shoulder 15′. The purpose of this spacer ring 25 is to allow for an adjustment of the rotational position of the jointed head 3 after the connection flange 2 has been screwed in, and with it the jointed head 3. The jointed head 3, with its joint axis A, is always oriented in the same direction in relation to the position of the buffer 10 in its circumferential direction. In the event of a deviation in this perpendicular orientation, the spacer ring 25, after releasing and removal of the connection flange 2, can be reduced in its thickness by a corresponding amount until this perpendicular orientation is fulfilled. The spacer ring 25 could also be replaced by another with the required thickness.

In addition to this, the annular stepping configuration 15 arranged behind the inner thread 13 in the hole 1′ of the buffer sleeve 1 is placed in such a way that the inner thread 13 essentially corresponds to the length of the outer thread 12 in the axial direction, in order for the outer thread to be screwed completely into the inner thread. As a result, this screw connection exhibits the required structural length for a secure fastening.

In order to prevent the possibility of this screw connection 12, 13 coming loose as a result of the pressure and traction forces which take effect on it when in operation, the buffer 10 is provided with two anti-rotation securing means 16, 17, accessible from the outside and arranged diametrically opposite one another, by means of which, in the assembled state, the connection flange 2 is permanently fixed to the buffer sleeve 1. As can be seen from FIG. 3, the anti-rotation securing means 16, 17 are configured as corresponding clamping shoes 18, each of which engage in a cut-out opening 22, 23, in the buffer sleeve 1 and in the connection flange 2, which are fixed in the connection flange 2 with screws 19 arranged radially.

The buffer piston rod 2 is provided in turn with an anti-rotation securing means, ensuring the free sliding movement of the buffer piston rod 4 in the buffer sleeve 1, which, as can be seen from FIG. 2, is composed of two diametrically opposed longitudinal wedge elements 21, arranged between the buffer piston rod and buffer sleeve, and the corresponding longitudinal grooves 20 in the hole 1′ of the buffer sleeve 1.

Both these anti-rotation securing means 16, 17 and the diametrically opposed longitudinal wedge elements 21, arranged between the buffer piston rod and the buffer sleeve, and the longitudinal grooves 20 in the hole 1′ of the buffer sleeve 1 are arranged with their axes in the same plane as the joint axis A of the jointed head 3. This also serves as orientation of the latter in the buffer 10.

It is of course possible, within the framework of the invention, for the anti-rotation securing means for the buffer sleeve 1 and the buffer piston rod 4 to be configured in another manner, provided that they can fulfil the function assigned to them heretofore. For example, it would be possible for only one longitudinal wedge element and one longitudinal groove to be provided, or vice-versa, wherein the longitudinal wedge element 21 could be arranged in the buffer sleeve 1 and the longitudinal groove could be arranged in the buffer piston rod.

The buffer according to the invention is characterized by a structurally simple and compact design, which in the assembled state ensures a secure and stable connection between the jointed head 3 and the buffer piston rod 4. It is of advantage in this situation that the constituent parts of the connection, namely the threads 12 and 13, the centering tip element 14, and the stepping configuration 15, serving as a contact surface, are all located well protected in the buffer sleeve 1. The installation of the buffer can be carried out easily from one side, without rotation.

The invention has been adequately described by way of the foregoing exemplary embodiments. It could also be explained by other variants, however. As securing means, use may be made of threads which are fine, circular, trapezoidal, normal, or of other formats. The anti-rotation securing means for fixing the buffer sleeve to the connection flange could also be provided in other forms, such as, for example, one or more screws or other securing elements, which would secure these elements directly to one another. In principle, depending on the situation, it would be possible to do without such anti-rotation securing means, and, if appropriate, also without a centering tip element. Likewise, it would also be possible to do without the spacer ring.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

1. Buffer, in particular for a rail vehicle, which is provided with a buffer sleeve, forming a pressure chamber, a jointed head securable to the sleeve on a face side by a connection flange, and a buffer piston rod, mounted opposite in the buffer sleeve to be displaceable longitudinally, wherein the jointed head is connectable in a jointed manner to the rail vehicle, while the buffer piston rod is connectable to a coupling head or another connection element, wherein the connection flange of the jointed head comprises an outer thread on its outer casing, which is screwed to an inner thread in a hole of the buffer sleeve in order to form a releasable connection of the jointed head to the buffer sleeve, whereby the connection flange is provided on the front side with a centering tip element arranged in front of the outer thread, which is slidable or pressablee essentially free of play into the hole of the buffer sleeve.

2. Buffer according to claim 1, wherein the hole of the buffer sleeve is configured behind the inner thread with an annular stepping configuration, which serves as a front-side contact of a shoulder at the connection flange in the buffer sleeve.

3. Buffer according to claim 1, wherein in the assembled state the connection flange is fixed to the buffer sleeve by at least one anti-rotation securing means which is accessible from the outside.

4. Buffer according to claim 3, wherein the buffer is provided with two diametrically opposed anti-rotation securing means.

5. Buffer according to claim 3, wherein the respective anti-rotation securing means is configured as a clamping shoe, engaging correspondingly in each case in a cut-out opening in the buffer sleeve and in the connection flange, which are fixed to the connection flange with radially arranged screws.

6. Buffer according to claim 1, wherein the buffer piston rod is provided with an anti-rotation securing means which ensures the free longitudinal displacement of the buffer piston rod in the buffer sleeve.

7. Buffer according to claim 6, wherein the anti-rotation securing means is comprises a longitudinal wedge element on the outside at the buffer piston rod and a corresponding longitudinal groove in the hole of the buffer sleeve, or vice-versa.

8. Buffer according to claim 2, wherein the annular stepping configuration, arranged in the hole of the buffer sleeve behind the inner thread, and the inner thread correspond essentially to the length of the outer thread in the axial direction, in order for the outer thread to be screwed entirely with the structural length required into the inner thread.

9. Buffer according to claim 2, wherein a spacer ring is in the stepping arrangement, which is arranged between the stepping arrangement and the shoulder, wherein, with this spacer ring rotation position of the connection flange is adjustable, and, with this, also of the jointed head in the screwed state, by means of which the jointed head, with its joint axis is always orientable in the same way in relation to the position of the buffer in its circumferential direction.

10. Buffer according to claim 9, wherein in the event of a deviation in this orientation of the rotation head, in the screwed state of this spacer ring, the ring is reducable in its thickness by a corresponding amount until this correct orientation in the screwed state has been adjusted and set.
